(19) United States
(12) Patent Application Publication
(10) Pub. No.: US 2003/0078884 A1
(43) Pub. Date: Apr. 24, 2003

(54) Method for facilitating commercial transactions through a global community payment network

(76) Inventor: Rodney Don Bauman, Burbank, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/302,366

(22) Filed: Nov. 22, 2002

Related U.S. Application Data
(63) Continuation-in-part of application No. 09/572,757, filed on May 16, 2000.

(51) Int. Cl. G06F 17/60

(52) U.S. Cl. 705/39

(57) ABSTRACT

The present invention is a method comprising establishing a Global Community Payment Network of multiple member accounts, establishing a first account for a member, establishing a second account for an other member or merchant/provider, receiving instructions from the member to pay an invoice of the other member or merchant/provider and transferring value from the first account to the second account to cover the invoice anonymously without requirement of a bank account, Social Security number or other national or regional identification. As the network does not have or use such information, no personal or financial can be exposed to other members, merchant/providers or anyone else. The method also includes defining a fixed valuation unit independent of a preexisting economy, establishing an exchange rate for each of a plurality of currencies including an electronic scrip pegged to the fixed valuation unit at a time the fixed valuation unit is defined, and adjusting the exchange rate for one of the plurality of currencies independent of the exchange rates of the other of the plurality of currencies. The method also comprises identifying a member using a code containing the date, time, and place of birth. A Global Community Payment Network would use such a unique identification number without the need of further identification such as Social Security numbers, etc.

### CROSS REFERENCE TO A RELATED APPLICATION

This is a continuation-in-part of Ser. No. 09/572,757 filed May 16, 2000 and entitled “METHOD FOR FACILITATING COMMERCIAL TRANSACTIONS.”

### BACKGROUND OF THE INVENTION

1. Field of the Invention

The invention relates to a business method for facilitating commercial transactions through a Global Community Payment Network and more particularly to a method establishing a fixed electronic standard against which all currencies and other forms of economic value are measured and indexed independently without regard to any other currency or flexible value.

2. Background

Currently, there are several on-line companies that enable customers to pay bills by credit card and provide merchants with the ability to accept payments on-line and to process transactions electronically. FIG. 1 illustrates a schematic diagram of the prior art, wherein a transaction facilitator funds a clients account from a personal bank account or credit card and transfer funds from a client's account to another person with an e-mail address, bank account, credit card and Social Security Number. For example, PayPal 50 is an on-line service that allows a client to send money from, for example, client's Paypal account 10 to someone with an e-mail address, bank account, credit card and Social Security Number 15. Client 11 logs into client account 10 and chooses Send Money. Client 11 then enters person's e-mail address 15 and the dollar amount. That person receives an e-mail informing her of the payment availability and, if she has the required bank account, credit card and Social Security Number, she can register at PayPal.com to claim her money in US Dollars. All transactions are in US Dollars. There is no specific provision for international transactions. Financial information, such as credit card and bank account numbers, are obtained and held by PayPal, but not divulged to the recipient who only sees the client's name and e-mail address. If funds are not available in the client's account, PayPal automatically charges the client's credit card or linked bank account.

No system currently exists wherein which no credit card, bank account, Social Security Number, national or other regional identification is required or revealed in any form to the transaction facilitator or anyone else.

Related to confidentiality and member identity, it is physically impossible for more than one person to be born at the same time and place—even if they are born at the same instant in the same general area or in close proximity of each other. Even in the event of multiple births by the same mother, there must be at least some time difference. Based on that logic, a code containing the date, time, and precise place of birth would uniquely identify any being on earth. Such a code can be used to uniquely identify members of a global community payment network without need for a Social Security number or any other form of identification.

Concerning the transaction itself, though various standards have been attempted in the past, they have all been ultimately found flawed and impractical. In absence of a fixed standard, the financial world currently relies on different fluctuating monetary indices, such as the Dollar. Obviously this is not a fixed independent standard. As the American economy changes, so does the value of the dollar itself. Therefore, the difficulty of using that or any national currency is that all other currencies relate to the economy of the primary standard currency. A universal, fixed valuation unit eliminates this fluctuation by setting a standard by which the relative value of all currencies is measured and indexed. Such an index is fixed and immutable. Unlike national, regional or other forms of currency, an index or related global community electronic scrip cannot be physically destroyed, duplicated, forged or stolen. Gold and other precious metals or materials have been accepted as semi-fixed standards in the past. Such poor substitutes fail in various ways, not the least of which is that the material itself is mutable and can be destroyed, lost or stolen. Consider the gold stolen by the Nazis—at least some of which has been lost or lies buried on land and in the sea. Had a global community electronic value been in existence prior to WW-II, millions of Holocaust victims and families could not have been economically destroyed. The same is true for any war and manmade or natural disaster.

### SUMMARY

What is disclosed is a method for facilitating commercial transactions through a global community payment network, in particular establishing a fixed standard index independent of any existing currency, physical material or other volatile reference. The exchange rate for any particular currency will fluctuate relative to the fixed standard index independent of other currencies. In one embodiment, the method involves establishing a Global Community Payment Network of accounts wherein a member can direct that value be debited from her own account for credit to a specified second account as requested or invoiced by the second account holder. The method also comprises defining a valuation unit independent of a preexisting economy, establishing an exchange rate for each currency at a time prior to the initial transaction employing the method and that currency, and adjusting the exchange rate for that currency independent of the exchange rates of the others of the plurality of currencies.

The method also comprises identifying a member using a code containing the date, time, and place of birth. The network would use such a unique identification number without the need of further identification such as Social Security number.

In one embodiment of the invention, an Electronic Global Community Scrip pegged to a fixed standard may be used for online and other traditional brick-and-mortar type transactions. Individual members of this global community are identified by a birth identification code that contains their unique date, time and place of birth. In the case of legal entities such as merchants, companies, corporations, partnerships, etc., the network can assign a similar code. For example the place of business and the time of registration with the network would provide the same singularity as for an individual. Within the same code, legal entities can also be distinguished from individuals.

### BRIEF DESCRIPTION OF THE DRAWINGS

The invention is illustrated by way of example and not by way of limitation in the figures of the accompanying drawings in which like references indicate similar elements and in which:

FIG. 1 illustrates a schematic diagram of prior art, wherein the transaction facilitator transfers funds from the client's account to a person's e-mail address;

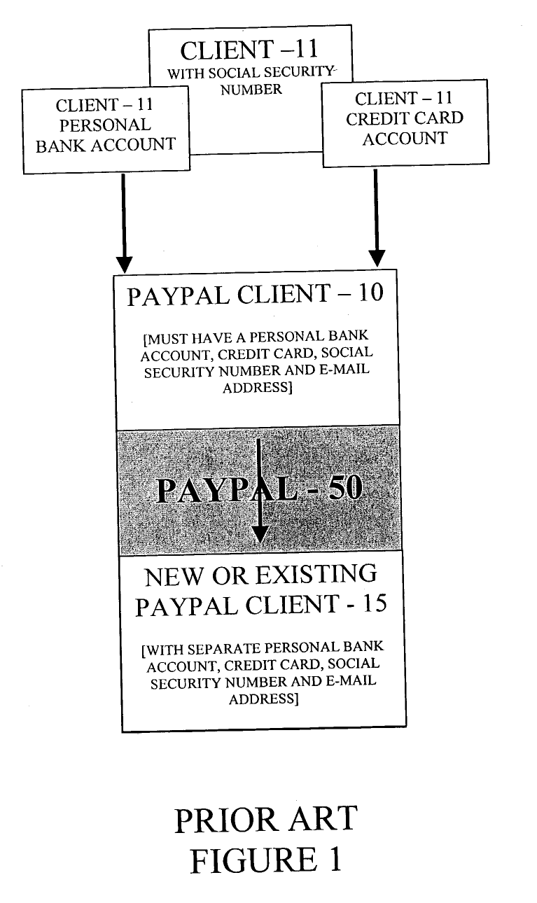

FIG. 2 illustrates a schematic diagram of a Global Community Payment Network of member accounts that receives instructions from a member to pay an invoice from another member or merchant/provider, according to one embodiment of the invention;

FIG. 3 illustrates a schematic diagram of a member that directs the network to pay an invoice, according to one embodiment of the invention;

FIG. 4 illustrates a schematic diagram of a merchant/provider reversal, refund or rebate procedure, according to one embodiment of the invention;

FIG. 5 illustrates a schematic diagram of a member that instructs a third party or financial institution to send funds to the transaction facilitator for deposit to member's account, according to one embodiment of the invention;

FIG. 6 illustrates a schematic diagram of a member that establishes in a financial institution a secondary account linked to the member's account in the transaction facilitator, according to one embodiment of the invention.

FIG. 7 illustrates a schematic diagram of an escrow procedure, according to one embodiment of the invention.

FIG. 8 illustrates a schematic diagram of a three-by-three locator matrix, representing one of 129,600 earth degree units (an area defined by single degrees of latitude and longitude) where each unit is further divided into nine sub-units, according to one embodiment of the invention.

FIG. 9 illustrates a schematic diagram of a Global Community Payment network, according to one embodiment of the invention.

### DETAILED DESCRIPTION

A. Transaction Facilitation Between a Member and a Merchant/Provider or Between Individual Members

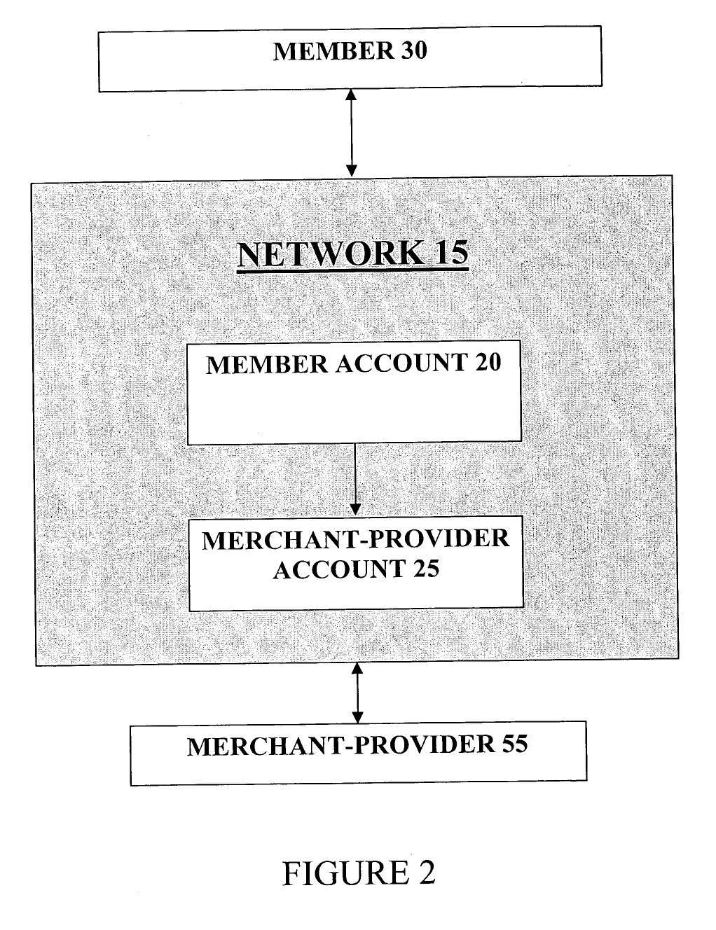

FIG. 2 illustrates a schematic diagram wherein a Global Community Payment Network 15 establishes member account 20 for member 30 based on minimal information provided to network 15 (e.g., no bank account, credit information, Social Security or other national identification is required. Email address is also optional) by member 30, and establishes merchant/provider account 25 for a merchant/provider 55, according to one embodiment of the invention. Merchant/provider account 25 is established based on information provided to transaction facilitator 15 by merchant/provider 55. When the network 15 receives funds from member 30 through a network agent, electronic funds transfer, deposit to a network account at a bank or financial institution or other means, network 15 converts currency to global community electronic scrip pegged to the relative universal denomination index and credits member account 20 with the relative electronic value of the deposited currency. When the network receives instructions from member 30 to pay an invoice of the designated merchant/provider 55, network 15 debits member account 20 and credits merchant/provider account 25 for the value of the invoice indicated by member 30 and notifies both merchant/provider 55 and member 30 that the amount pursuant to the specified invoice has been transferred to merchant/provider account 25, according to one embodiment of the invention. If there are not sufficient funds available in member account 20 to pay the invoice and no previous arrangement to cover overdrafts has been established, network 15 will reject the transaction and notify member 30 of the need to deposit at least enough to cover the proposed invoice payment.

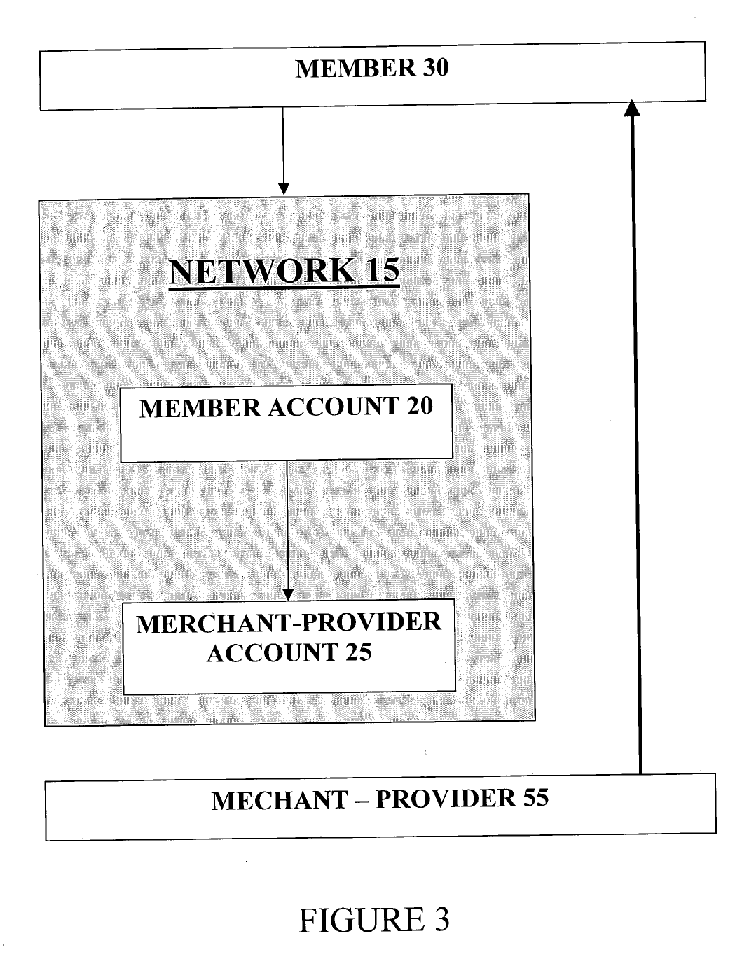

FIG. 3 illustrates a schematic diagram wherein member 30 orders services or goods from merchant/provider 55 that has merchant/provider account 25 with network 15, according to one embodiment of the invention. Merchant/provider 55 provides the member 30 with an invoice payable in network fixed value units. Member 30 then directs the network to debit her member account 20 in the amount of the invoice and to credit the merchant/provider account 25 referencing the related invoice/reference number. Network 15 complies with member 30 order and notifies both member 30 and merchant/provider 55 that the proper electronic value for the specific invoice has been transferred to merchant/provider account and merchant/provider 55 delivers the requested goods or services to member 30, according to one embodiment of the invention.

Since the member discloses no personal, credit or financial information at any time. Risk of identity theft is virtually zero. The member has complete control of her account, which cannot be debited by anybody other than the network and only upon her order. Moreover, since no information needs to be exchanged with the merchant/provider 55, completely anonymous transactions may be conducted either online or through a brick and mortar environment. In the case of an anonymous transaction, the merchant/provider 55 issues an invoice to the member 30, which effectively indicates a price for the goods or services sought. The member 30 directs the network 15 to pay the invoice and the merchant releases the goods upon notification of payment. Throughout this process, the merchant never received any information about the member 30, not even an account number. Thus, the transaction is deemed anonymous similar to an all cash transaction.

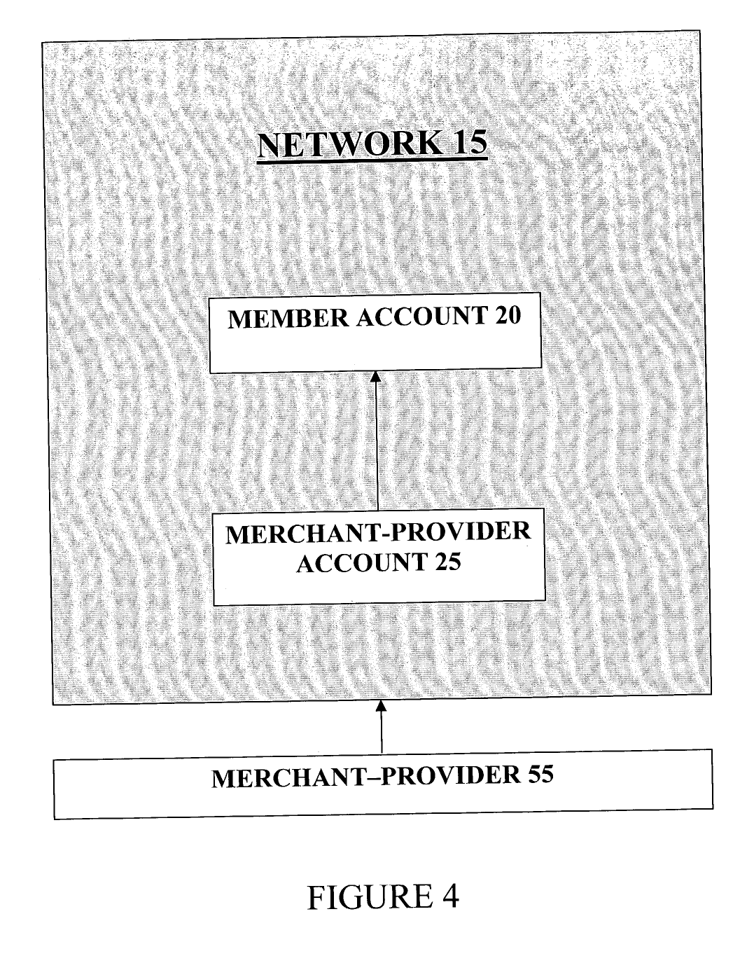

FIG. 4 demonstrates the case wherein a reversal, refund or rebate is in order. Merchant/provider 55 directs network 15 to transfer funds from merchant/provider account 25 to member account 20 with reference to the appropriate invoice or reference number. Network 15 debits merchant/provider account, credits member account 20 for the prescribed fixed valuation units and notifies both merchant/provider 55 and member 30 that member account 20 has been credited, according to one embodiment of the invention.

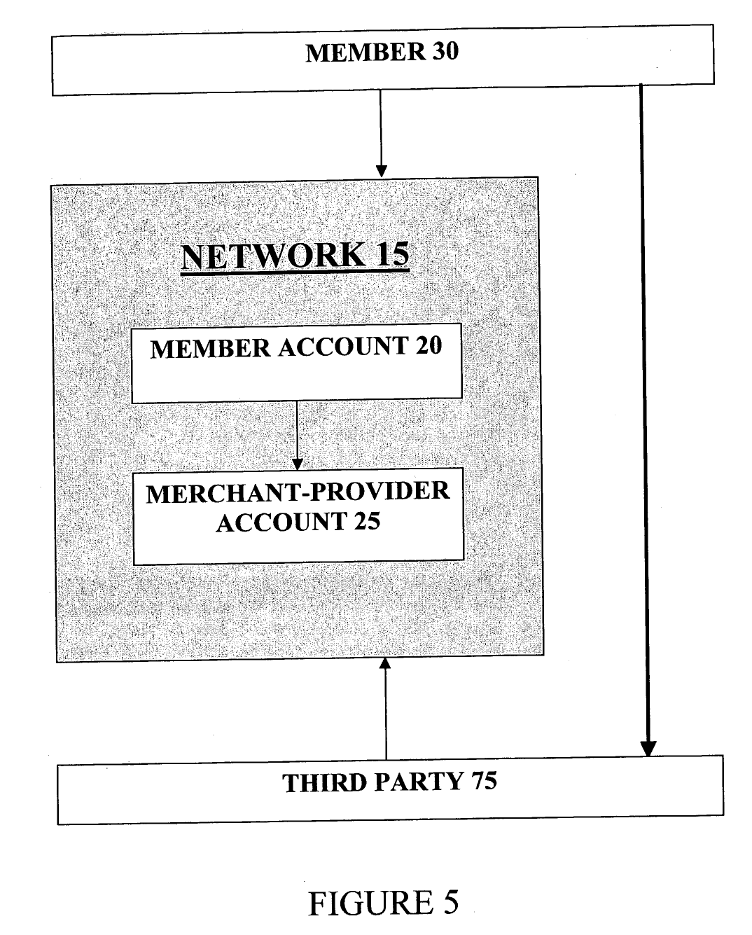

FIG. 5 illustrates a schematic diagram wherein a member instructs a third party 75 or financial institution to send value to network 15 for credit to member account 20, according to one embodiment of the invention. For transactions conducted over the Internet, the invoice may be provided automatically to transaction facilitator 15, via a third party 75. When member 30 places an order on the Internet or by other means, and immediately receives a confirmation from the merchant, member 30 will simultaneously provide instructions to third party 75 to send the confirmation regarding the order to transaction facilitator 15.

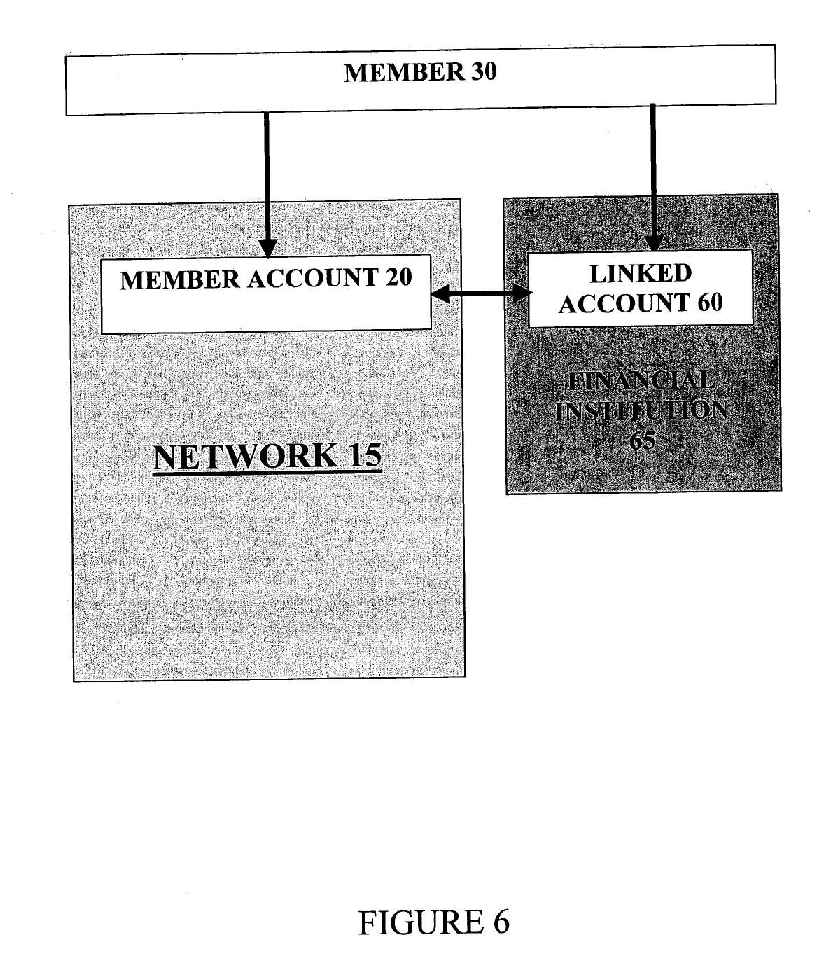

FIG. 6 illustrates a schematic diagram of member 30 that establishes in financial institution 65 a linked account 60, which is secondary and linked to member account 20 in transaction facilitator 15, whereby member 30 may transfer funds between the two accounts, according to one embodiment of the invention.

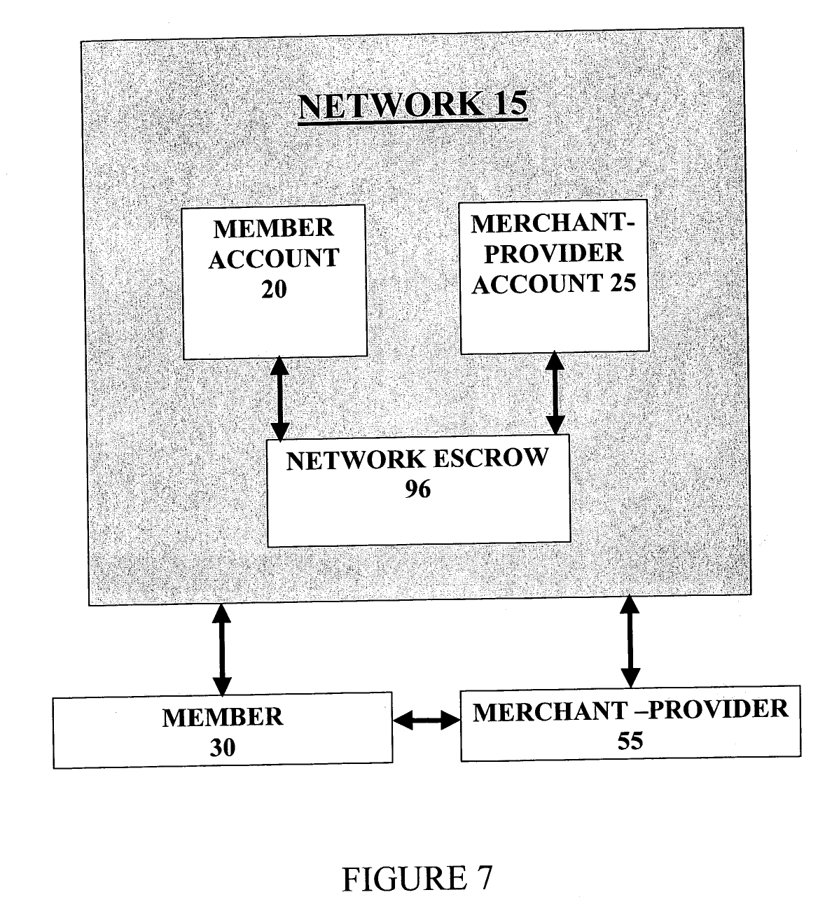

FIG. 7 illustrates a schematic diagram wherein network 15 establishes an escrow account for a transaction between member 30 and merchant/provider 55, according to one embodiment of the invention. Either member 30 or merchant/provider 55 may request escrow. When both member 30 and merchant/provider 55 have agreed to the terms and conditions of the escrow and notified network 15, network 15 will debit the member account 20 for the value to be escrowed and hold it in the escrow account 96. Network 15 will notify merchant/provider that the value is being held in escrow. Merchant/provider 55 delivers the item to member 30. When member 30 notifies network 15 that she is satisfied, network 15 releases the escrowed value to merchant/provider account 25. If member 30 notifies network 15 that she is not satisfied and has returned the item to merchant/provider 55 or that she has not received the item, the value will continue to be held until merchant/provider 55 notifies network 15 that the item has been received in acceptable condition. Network 15 will then release the value to member account 20. Disputes shall be submitted to binding arbitration, according to one embodiment of the invention.

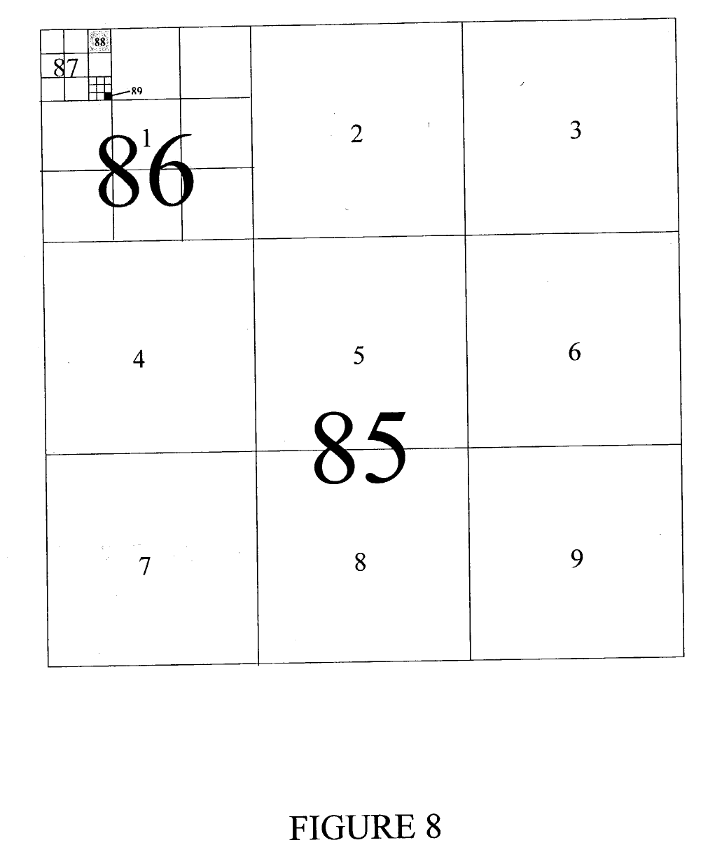

FIG. 8 illustrates a schematic diagram of a three-by-three locator matrix 5, representing one of 129,600 earth degree units (an area defined by single degrees of latitude and longitude). Each unit is identified by a 5 digit code derived by first dividing the globe in 8 sections defined by the equator and a longitudinal line through Greenwich (each section numbered 1-8), then dividing each of those 8 sections longitudinally into 9 equal sections numbered 1-9, each of which is divided longitudinally 10 equal sections numbered 0-9, each of which is divided latitudinally into 9 equal sections numbered 1-9 and each of those latitudinally into 10 equal sections numbered 0-9. The resultant earth degrees are then divided by creating a locator matrix of 3 by 3 units, according to one embodiment of the invention. This locator matrix 85, is divided into 9 equal units 86, numbered from left to right within a row of units and from top to bottom, in sequence from “1” to “9”. Each unit 86 is divided into nine sub-units 87. Sub-units 87 are further subdivided into nine other sub-units 88. Sub-units 88 are further subdivided into nine other sub-units [89], which are in turn subdivided, until a plurality of digits defines the place of birth of the member. Each digit will bring us closer to the physical location of the member's place of birth. “1” represents the northwest ninth of the earth-degree, “3” represents the northeast ninth of the earth-degree, “5” represents the central ninth of the earth-degree, “7” represents the southwest ninth of the earth-degree, and “9” represents the southeast ninth of the earth-degree, according to one embodiment of the invention. See, The Bauman Locator System by Gerald B. Bauman published in 1980 for additional details of such a coding system.

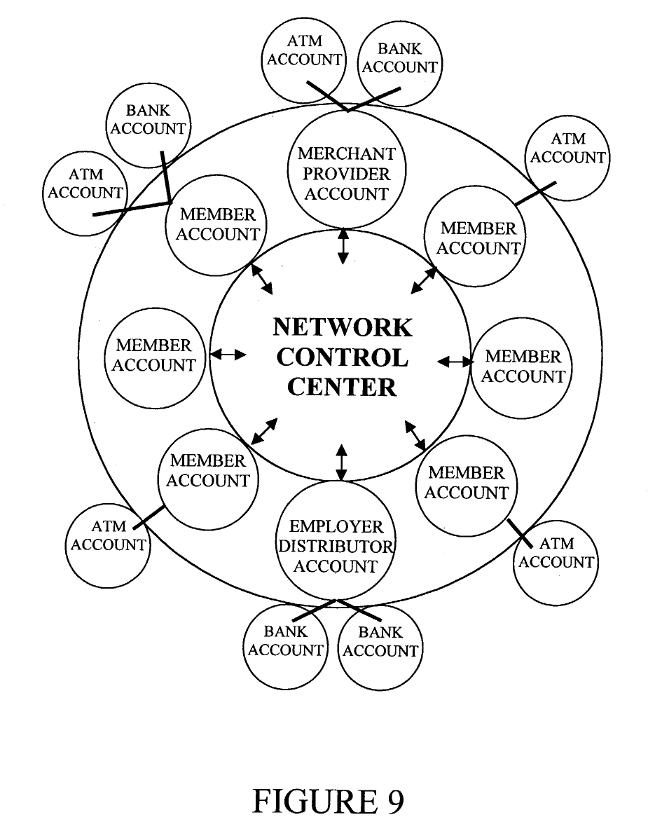

FIG. 9 illustrates a schematic diagram of a Global Community Payment network, wherein the network debits and credits fixed global community electronic value or pegged scrip among various member, merchant/provider, employer, distributor and other intranet accounts as directed by the individually independent account holders, according to one embodiment of the invention. Sub-accounts with links to a primary account may be established for funding and redemption of fixed global community electronic value or pegged global community electronic scrip in local currency through automatic teller machines and atm networks, banks, financial institutions, network agents, participating merchants, etc. Members and merchant/providers may exchange fixed electronic value between their linked accounts at will. Transactions between accounts that are not linked must be made through the network control center. Value transferred from a sub-account with atm or financial institution access is converted to the currency of the nation or region in which the account is domiciled and then converted to local currency at the current rate of exchange available through the network. Merchant/providers can invoice and receive one-time, progressive and installment payments. Refunds, premiums and dividends etc. can be distributed directly without the delays and costs of drafting and delivering checks by mail or other means. Employers can deposit salaries, expenses, bonuses, benefits and commissions, etc. directly to employees, contractors and suppliers, according to one embodiment of the invention.

B. Code Identifying the Member

Only one person can be born at the same time and place—even if they are born at the same instant in the same hospital or in close proximity of each other. Even in the event of multiple births by the same mother, there must be at least some time difference. Based on that logic, a code containing the date, time, and precise place of birth would uniquely identify any being on earth. Such a code can be used to identify members. The network may use such a unique identification number without need for any traditional identification such as a Social Security or driver's license, etc. Providing this code to network 15 in FIG. 3 or a clearinghouse eliminates the need for other traditional identification such as Social Security or credit card number, etc.

The plurality of digits that represent the place of birth of the member form part of a code used to identify the member. Other parameters of this code include: the date and local time of birth. Biometrics can be used in conjunction with the birth identification code for verification and controls against misrepresentation, fraud or unintentional data error.

C. Fixed Valuation Unit

A universal valuation unit sets a fixed standard by which the value of other currencies is measured with respect to this valuation unit. It is a totally independent system of measure that is not based on any currency. It can be compared to the metric system, which is unrelated to any country. For example, 10 meters (m) is exactly the same whether it is measured in China or the United States. Network 15, in FIG. 3, may transfer value using this universal valuation unit system.

The valuation unit is particularly useful in the area of international transactions. For example, if someone purchases something today and then a month later decides that a refund is in order, within an economy the change or fluctuation will not be vital since a refund of a $100 will be refunded as $100. However, between economies, the fluctuation can be tremendous. The exchange rate and value will be set at the time of the original transaction and is adjusted independently relative to changes in either economy, a day, a year or anytime later.

By way of another example, imagine someone from another economy such as Venezuela who exchanges bolivars at the then current rate of exchange (i.e. 500 bolivars per dollar) for the purchase of something worth $100 in the USA. It is well known that some economies like the Venezuelan, are very unstable and so the fluctuations in value of their currencies can be tremendous. At a later date, if the Venezuelan were to receive a refund or reversal credit of $100, it would automatically be converted to the current rate of exchange in bolivars (i.e. 1,000 bolivars per dollar) rather than the rate at the time of the original transaction. The US refunder will remit the same $100 and the Venezuelan will be able to convert it to 1,000 bolivars on a par with local inflation.

By the same token, an American who converts $100 to purchase something worth 500 bolivars and later is to receive a credit would only get $50 according to present day standards. In the case of the universal valuation unit standard the American would receive the full $100 which the Venezuelan would refund based on the current value of the bolivar within the Venezuelan economy.

By transacting in a universal valuation unit, these fluctuations will eliminate the case where a party will obtain an advantage or disadvantage of either economy's inflation. In the previous example, the Venezuelan would be refunded 100 Units that would not fluctuate according to any economy. This would result in a million bolivars if the Venezuelan decided to convert the Units.

It could also be devastating in the current system without a fixed valuation unit for an American who buys a house in Venezuela for bolivars equivalent to $20000, for example. Let us say that the American makes a deposit and the deal doesn't go through or is changed in some way. The same amount of bolivars would be returned to the American, but because of the Venezuelan economy's inflation, that amount of bolivars is now only worth $10000. This would result in substantial loss for the American.

As explained above, if the transaction were conducted using a universal valuation unit, the party would not have suffered a loss because the units would not have fluctuated with the Venezuelan economy and would still be equivalent to $20000 plus or minus any fluctuation in the US economy versus the fixed valuation unit. The relative universal denomination index may not solve the economic problems of the world, but so long as value is maintained or stored using this method, it is an effective hedge against national and regional currency fluctuations. It sets a frame of reference by which international business can be conducted globally with greater ease and security.

In many other countries such as Venezuela it is not legally permissible to write a contract other than in the local currency. Even if the parties desired to write the contract in dollars, because of the dollar's stability, then a lengthy contract relating dollars to bolivars would have to be drafted. Such a contract would run the risk of invalidation through subsequent legal proceedings. However, if a global exchange rate and valuation unit were used then it would be possible to lock in the value related to that universal denomination.

In another example, where an American makes plans to build a building in Venezuela, suppose that the value of bolivars or cost of material in the country changes drastically such that it will dramatically affect the cost. However, if the contract were drafted in the universal valuation unit, even if one economy went bad, each party would be affected only so far as their local currency varied with regard to the relative universal denomination index fixed value.

The network described above would transfer value in the universal valuation unit, according to the calculated exchange rate for the particular currency. As mentioned above, the network transaction facilitator may use a unique code or identification number without need for any traditional identification such as a Social Security or other national/regional identification number.

A substantial number of consumers worldwide do not rely upon traditional banking systems. This population is referred to as the “Unbanked.” In many countries it is largely composed of immigrant workers. In the US alone, more than 12% of the people do not have a bank account. For example, the Hispanic population in the United States currently comprises the largest minority. The majority of these Hispanic households do not have checking accounts and lack access to a credit or charge card. In one embodiment, the Global Community Payment Network may function as a low cost person-to-person and business payment solution for millions of “Unbanked”, Hispanic, and other consumers who need alternatives to mainstream financial institutions, checks, credit cards and wire transfers.

International itinerate workers and other people in many circumstances and walks of life regularly make international payments and send money to family and others abroad. Those without access to mainstream financial services must use non-bank sources to pay their bills, send, receive or manage money nationally or internationally. Some embodiments of the Global Community Payment Network are adaptable to meet the needs of the entire global community to send and receive money, make purchases and pay bills with a simple, fast, trustworthy and inexpensive method superior to current methods that are complicated, costly and require bank accounts, credit cards, social security numbers or other types of limited national or regional identification.

In one embodiment of the invention, the Global Community Payment Network responds to market demands through Global Community Electronic Scrip pegged to a Relative Universal Denomination Index not affected by national or other regional currencies or economies. This solution is a safe and effective method for individuals and business members of the network to send and receive funds, buy, sell, barter and manage financial transactions at substantially lower fees than previous technology would permit. Global Community Electronic Scrip cannot be forged, duplicated or stolen. It can be used in place of national or other regional currencies.

In some embodiments of the invention, the Global Community Payment Network offers superior low cost worldwide money management solutions in a secure member community with benefits to both individual and business members.

In the preceding detailed description, the invention is described with reference to specific embodiments thereof. It will, however, be evident that various modifications and changes may be made thereto without departing from the broader spirit and scope of the invention as set forth in the claims. The specification and drawings are, accordingly, to be regarded in an illustrative rather than a restrictive sense.

What is claimed is:

1. A method comprising:
establishing a first account for a member;
establishing a second account for another member or merchant/provider;
processing instructions from one member to pay an invoice of another member or merchant/provider, wherein no credit card or other financial or personal information is supplied;
transferring value in terms of a global electronic fixed value index or scrip from the first account to the second account to cover the invoice; and
establishing sub-accounts for transferring value to and from third party financial institutions or networks.

2. The method of claim 1, further comprising:
notifying at least one party when the transfer is complete.

3. The method of claim 1, further comprising:
identifying the member using a code of a plurality of digits; and
describing the place of birth of the member by a portion of the plurality of digits.

4. The method of claim 3, further comprising:
representing each of a plurality of digits of the place of birth of the member by a unit on a three-by-three locator matrix and specific variations of the matrix that can be in turn correlated to the Mercator system of global delineation.

5. The method of claim 3, wherein a global community payment network uses the code to identify a member.

6. The method of claim 4, further comprising:
identifying each of 129,600 earth degrees by first dividing the earth in eight sections defined by an equator and a longitudinal line through Greenwich, and numbered from “1” to “8”;
dividing each of the eight sections longitudinally into nine equal sections, in sequence from “1” to “9”;
dividing the nine equal sections longitudinally into ten equal sections, in sequence from “0” to “9”;
dividing the ten equal sections latitudinally into nine similar sections, in sequence from “1” to “9”;
dividing the nine equal sections latitudinally into 10 similar sections, in sequence from “0” to “9”; and
creating a locator matrix of 3 by 3 units from left to right within a row of units and from top to bottom, in sequence from “1” to “9”.

7. The method of claim 4, further comprising:
subdividing each unit into nine subunits; and
obtaining the place of birth of the member by multiple iterations of subdivision.

8. The method of claim 6, wherein “1” represents the northwest ninth of an earth-degree, “3” represents the northeast ninth of an earth-degree, “5” represents the central ninth of an earth-degree, “7” represents the southwest ninth of an earth-degree, and “9” represents the southeast ninth of an earth-degree.

9. A method comprising:
establishing an account and one or more sub-accounts for a member with a global community payment network;
receiving an order with an amount, a recipient network identification handle and an invoice or transaction identification code from the member ordering payment of the invoice from the member account;
debiting the member account;
crediting the recipient account as ordered by the member; and
notifying the member and recipient of a completed transaction.

10. The method of claim 9, wherein the network transfers value in a valuation unit based on a fixed value global community electronic index or scrip pegged thereto.

11. The method of claim 9, wherein a member may establish accounts in financial institutions that are linked to the account in the network.

12. The method of claim 9, further comprising:
instructing a third party or financial institution to send funds to the network for deposit into the account of a member, in the network.

13. The method of claim 9, wherein an individual or merchant/provider having an individual or merchant/provider account and one or more sub-accounts with the network may transfer value among those accounts.

14. The method of claim 9, wherein an individual or merchant/provider having one or more sub-accounts with the network for the purpose of converting global community value or scrip to local currency may redeem value in local currency from such accounts through automatic teller machines.

15. The method of claim 9, wherein an order for goods or services may be initiated by a member having a member account with the network.

16. The method of claim 9, wherein the transaction is conducted anonymously.

17. A method comprising:
establishing a merchant/provider account with a global community payment network;
receiving an order from a member to debit that member's account and credit the merchant account, indicating a relevant merchant invoice or reference number and notifying both parties that the amount has been credited to the merchant account with reference to the indicated invoice or reference number.

18. The method of claim 17, wherein transactions are conducted in a global community electronic scrip or valuation unit, independent of a preexisting national or regional economy or currency.

19. A method comprising:
defining a valuation unit independent of a preexisting national or regional economy or currency;
establishing an exchange rate for each of a plurality of currencies at a time the valuation unit is defined; and
adjusting the exchange rate for one of the plurality of currencies independent of the exchange rates of the other of the plurality of currencies.

20. The method of claim 19, wherein the value of other of the plurality of currencies is measured with respect to the valuation unit.

21. The method of claim 19, further comprising:
establishing a clearinghouse for transactions in the valuation unit wherein a unit of value for the transaction is fixed at the time of the transaction.

22. The method of claim 19, wherein a user desires to cancel a transaction of an item, refunding the user the fixed unit value of the item.

23. The method of claim 19, further comprising:
determining the cost of an item based on the valuation unit value of the item.

24. The method of claim 20, further comprising:
forming a contract using the valuation unit.
